(19) United States
(12) Patent Application Publication
(10) Pub. No.: US 2012/0194017 A1
(43) Pub. Date: Aug. 2, 2012

(54) REVERSING DEVICE FOR MOTOR

(75) Inventor: Huayun XIONG, Zhongshan (CN)

(73) Assignee: Zhongshan Broad-Ocean Motor Manufacturing Co.,Ltd., Zhongshan (CN)

(21) Appl. No.: 13/342,940

(22) Filed: Jan. 3, 2012

(30) Foreign Application Priority Data
Jan. 29, 2011 (CN) 201120035924.7

(51) Int. Cl. H02K 11/00

(52) U.S. Cl. 310/71

(57) ABSTRACT

A reversing device for a motor. The motor includes a motor body. The reversing device includes a wired socket and a reversing plug. The wired socket is mounted on the motor body and the reversing plug is inserted in the wired socket. The device is simple, safe, reliable, and practical. It features a self-locking function and a greater reliability with a fairly easy reversing operation.

### CROSS-REFERENCE TO RELATED APPLICATIONS

Pursuant to 35 U.S.C. §119 and the Paris Convention Treaty, this application claims the benefit of Chinese Patent Application No. 201120035924.7 filed Jan. 29, 2011, the contents of which are incorporated herein by reference.

### BACKGROUND OF THE INVENTION

1. Field of the Invention

The invention relates to a reversing device for a motor.

2. Description of the Related Art

Conventional reversing methods for a dual steering motor is to introduce four lead wires from a motor winding with two connecting the female terminals and the other two connecting the male terminals. The motor achieves forward or reverse rotation by interchanging the wires of the female terminals and the male terminals at the lead wire end. However, such a method has the following disadvantages:
1) the exposed lead wires introduced from the motor winding are too long, thus affecting the motor appearance, and moreover the lead wires are likely to become loaded. Consequently they are operated inconveniently and have poor reliability;
2) it is complicated to interchange the terminals when the motor needs to change directions; and
3) no interlock function for the wiring of the male terminals and the female terminals, thus the wires are easy to become loose.

### SUMMARY OF THE INVENTION

In view of the above-described problems, it is one objective of the invention to provide a reversing device for a motor, which is simple, safe, reliable, practical, and beautiful, and moreover the reversing operation is fairly easy. The device is provided with self-locking function and thus has a greater reliability.

To achieve the above objective, in accordance with one embodiment of the invention, there provided is a reversing device for a motor, the motor comprising a motor body, and the reversing device comprising a wired socket and a reversing plug, wherein the wired socket is mounted on the motor body and the reversing plug is inserted in the wired socket.

In a class of this embodiment, the wired socket comprises a plurality of socket holes with each having a terminal sleeve and a coil winding is electrically connected with the terminal sleeves; the reversing plug comprises a plurality of round pins, each round pin has a recess that is mounted with a pin terminal, every two pin terminals are connected with each other; the round pins are embedded in the socket holes and the pin terminals are connected with the terminal sleeves.

In a class of this embodiment, the motor body is a motor casing.

In a class of this embodiment, two sides of the wired socket are arranged with clip slots; the wired socket is embedded in a gap at the end of the motor casing; the clip slots are fastened at two side walls of the gap; and one end of an end cover of the motor presses on the bottom side surface of the wired socket.

In a class of this embodiment, the reversing device is in the shape of a cube.

In a class of this embodiment, the motor body is an end cover of the motor.

In a class of this embodiment, the wired socket comprises an upper portion and a lower portion, and a step surface is formed therebetween. The wired socket is embedded in a slot at the end surface of the end cover of the motor; a plurality of elastic clips arranged on the outer side surface at the lower portion of the wired socket are clamped on the inner wall surface of the end cover of the motor, and the step surface presses on the outer surface of the end cover of the motor.

In a class of this embodiment, the reversing device is in the shape of a cylinder.

In a class of this embodiment, the wired socket and the reversing plug are coupled together by a locking device.

In a class of this embodiment, the locking device comprises a buckle projected from the wired socket and a buckle plate arranged on the reversing plug, in which the buckle is fastened in a through hole on the buckle plate.

Advantages of the invention are summarized below:
1) the reversing device comprises a wired socket and a reversing plug, in which the wired socket is mounted on the motor body and the reversing plug is inserted in the wired socket; the wired socket comprises a plurality of socket holes with each having a terminal sleeve and the coil winding is electrically connected with the terminal sleeves; the reversing plug comprises a plurality of round pins, each round pin has a recess that is mounted with a pin terminal, every two pin terminals are connected with each other, the round pins are embedded in the socket holes and the pin terminals are connected with the terminal sleeves. Such a structure is simple, safe, reliable, practical and beautiful, and moreover the reversing operation is fairly easy;
2) the motor body is a motor casing, two sides of the wired socket are arranged with clip slots, the wired socket is embedded in a gap at the end of the motor casing, the clip slots are fastened at two side walls of the gap and the end of an end cover of the motor presses on the bottom side surface of the wired socket, and the reversing device is in the shape of a cube. Such a structure is simple, mounting friendly and applicable to drum motors; and
3) the motor body is an end cover of the motor, the wired socket comprises an upper portion and a lower portion, and a step surface is formed therebetween, the wired socket is embedded in a slot at the end surface of the end cover of the motor, a plurality of elastic clips arranged on the outer side surface at the lower portion of the wired socket are clamped on the inner wall surface of the end cover of the motor, the step surface presses on the outer surface of the motor end cover and the reversing device is in the shape of a cylinder. Such a structure is practical, reasonable, mounting friendly, and extremely versatile; and
4) the wired socket and the reversing plug are coupled together by a locking device, which comprises a buckle projected from the wired socket and a buckle plate arranged on the reversing plug, and the buckle is fastened in a through hole on the buckle plate. The device is provided with self-locking function and thus has a greater reliability.

### BRIEF DESCRIPTION OF THE DRAWINGS

FIG. 1 is a three-dimensional diagram of a reversing device mounted on a motor body in accordance with one embodiment of the invention;

FIG. 2 is an exploded view of a reversing device mounted on a motor body in accordance with one embodiment of the invention;

FIG. 3 is a three-dimensional diagram of a reversing device in accordance with one embodiment of the invention;

FIG. 4 is an exploded view of a reversing device in accordance with one embodiment of the invention;

FIG. 5 is a three-dimensional diagram of a reversing device mounted on a motor body in accordance with another embodiment of the invention;

FIG. 6 is an exploded view of a reversing device mounted on a motor body in accordance with another embodiment of the invention;

FIG. 7 is a sectional view of a reversing device mounted on a motor body in accordance with another embodiment of the invention;

FIG. 8 is a partial enlarged view of A-A of FIG. 7;

FIG. 9 is a three-dimensional diagram of a reversing device in accordance with another embodiment of the invention; and

FIG. 10 is an exploded view of a reversing device in accordance with another embodiment of the invention.

### DETAILED DESCRIPTION OF THE EMBODIMENTS

For further illustrating the invention, experiments detailing a reversing device for a motor are described below. It should be noted that the following examples are intended to describe and not to limit the invention.

### Example 1

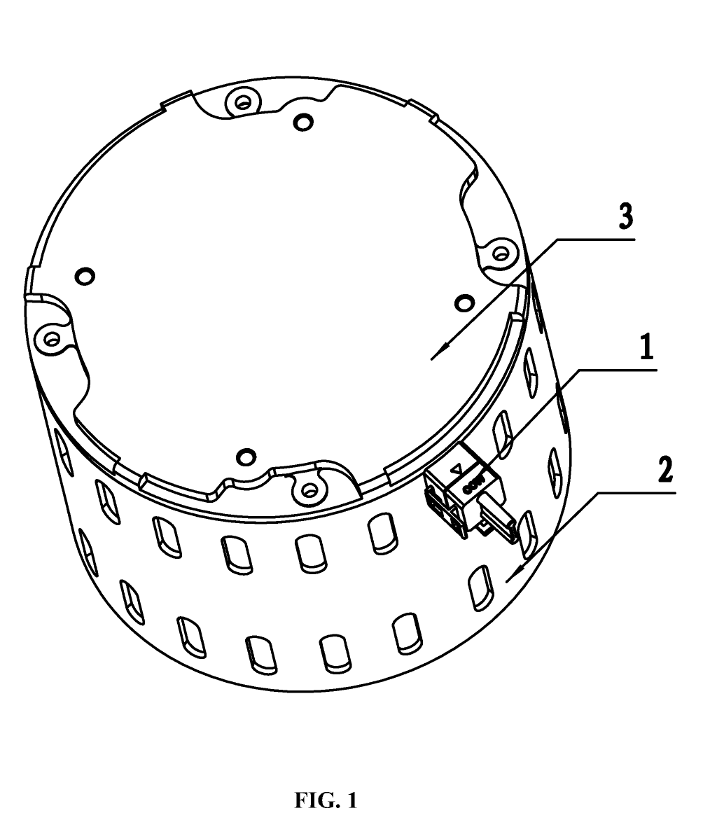

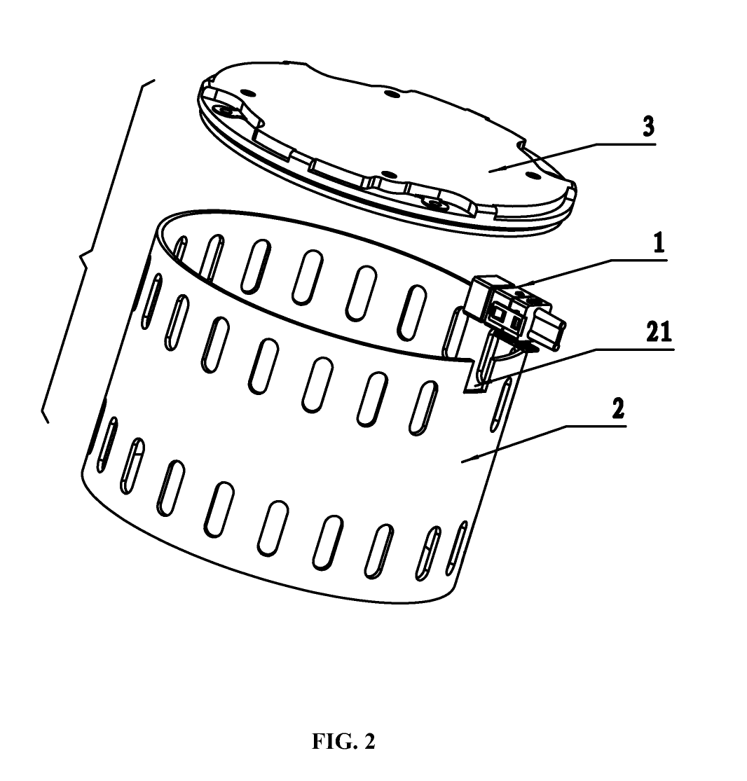

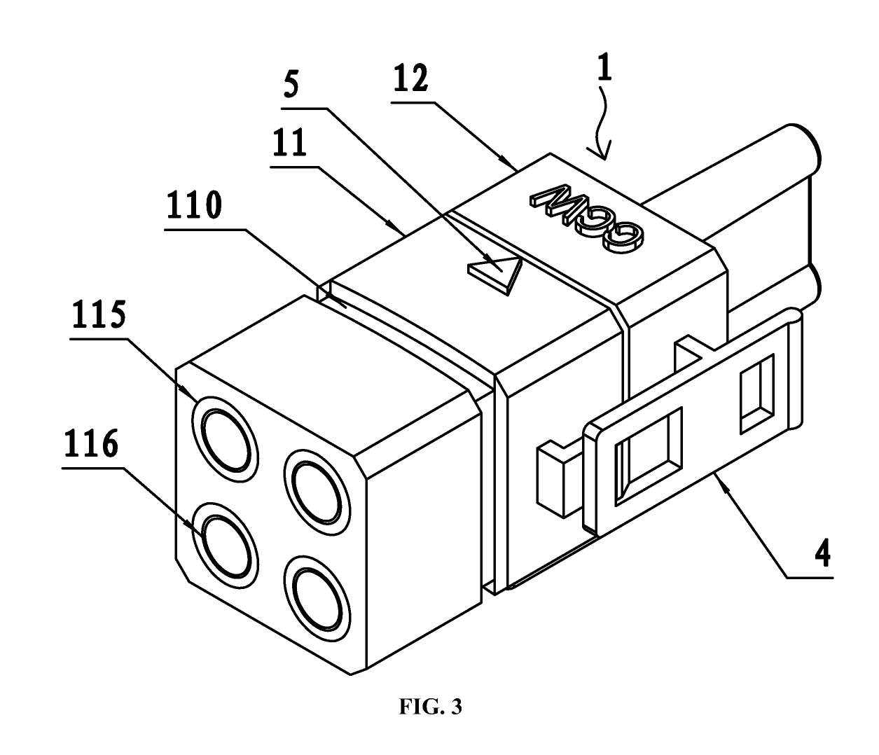

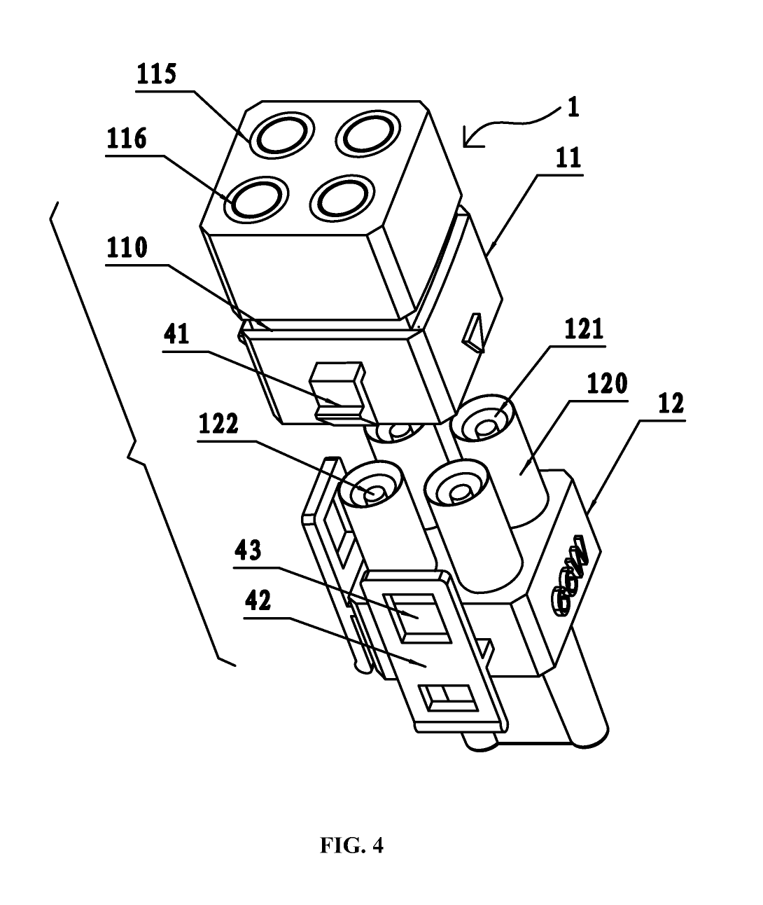

As shown in FIGS. 1-4, a reversing device 1 for a motor comprises a wired socket 11 and a reversing plug 12. The motor comprises a motor body. The wired socket 11 is mounted on the motor body and the reversing plug 12 is inserted in the wired socket 11. The wired socket 11 comprises a plurality of socket holes 115 with each having a terminal sleeve 116 and the coil winding is electrically connected with the terminal sleeves 116. The reversing plug 12 comprises a plurality of round pins 120. Each round pin 120 has a recess 121 that is mounted with a pin terminal 122, and every two pin terminals 122 are connected with each other. The round pins 120 are embedded in the socket holes 115 and the pin terminals 122 are connected with the terminal sleeves 116. The motor body is a motor casing 2. Two sides of the wired socket 11 are arranged with clip slots 110. The wired socket 11 is embedded in a gap 21 at the end of the motor casing 2. The clip slots 110 are fastened at two side walls of the gap 21 and the end of an end cover 3 of the motor presses on the bottom side surface of the wired socket 11. The reversing device 1 is in the shape of a cube. The wired socket 11 and the reversing plug 12 are coupled together by a locking device 4. The locking device 4 comprises a buckle 41 projected from the wired socket 11 and a buckle plate 42 arranged on the reversing plug 12, in which the buckle 41 is fastened in a through hole 43 on the buckle plate 42. The reversing device 1 is arranged with a sign 5 to indicate the forward or reverse rotation.

### Example 2

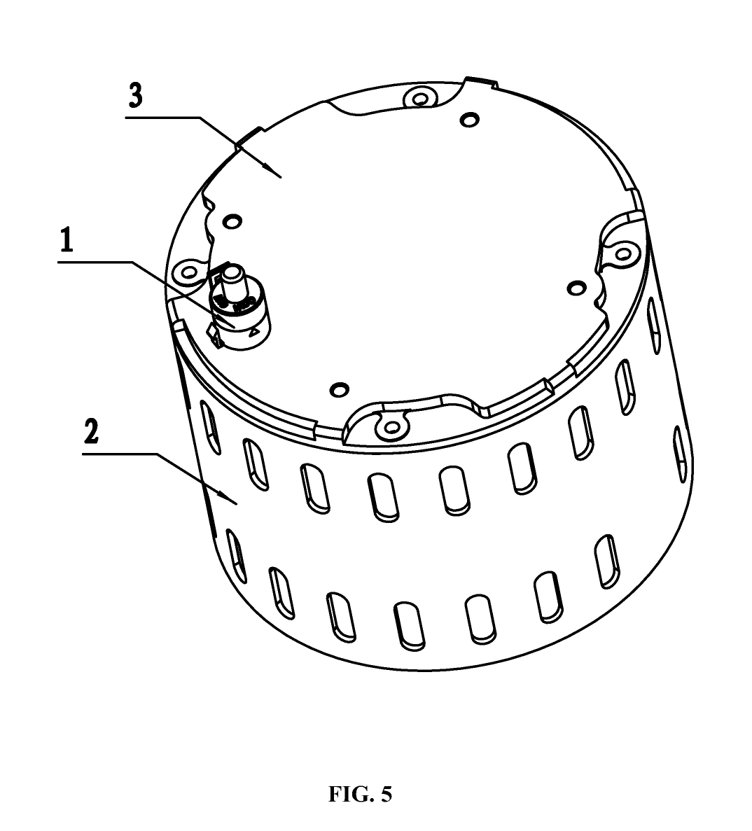

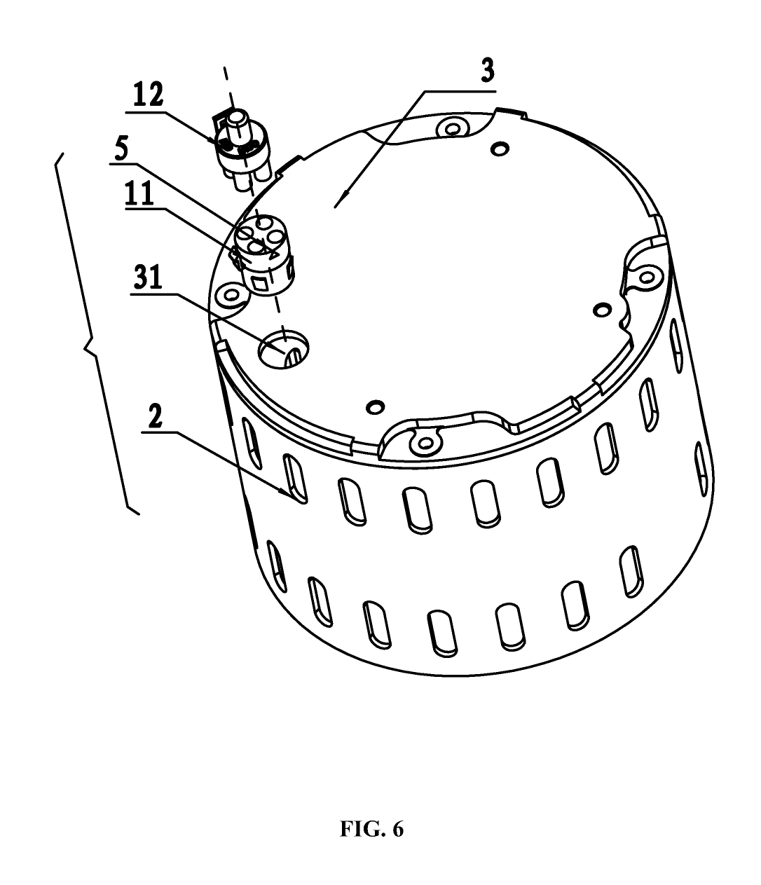

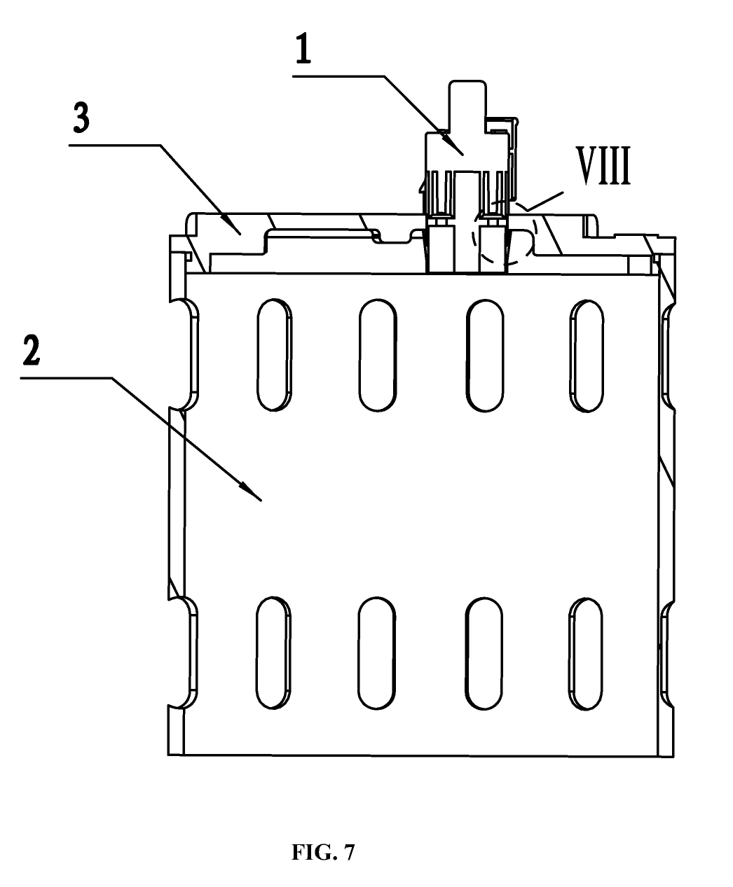

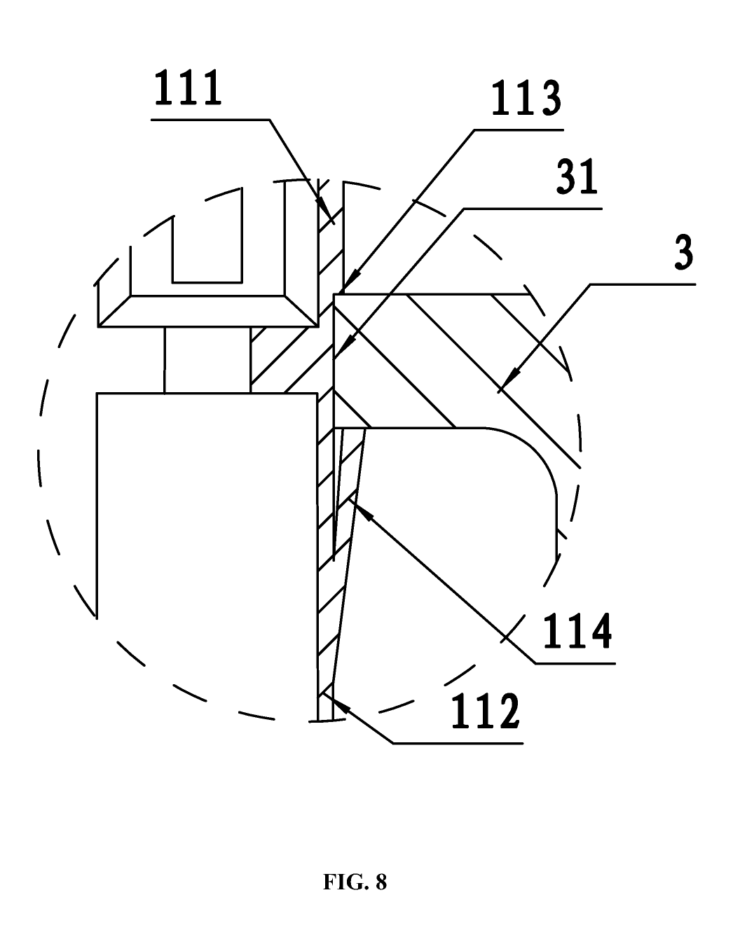

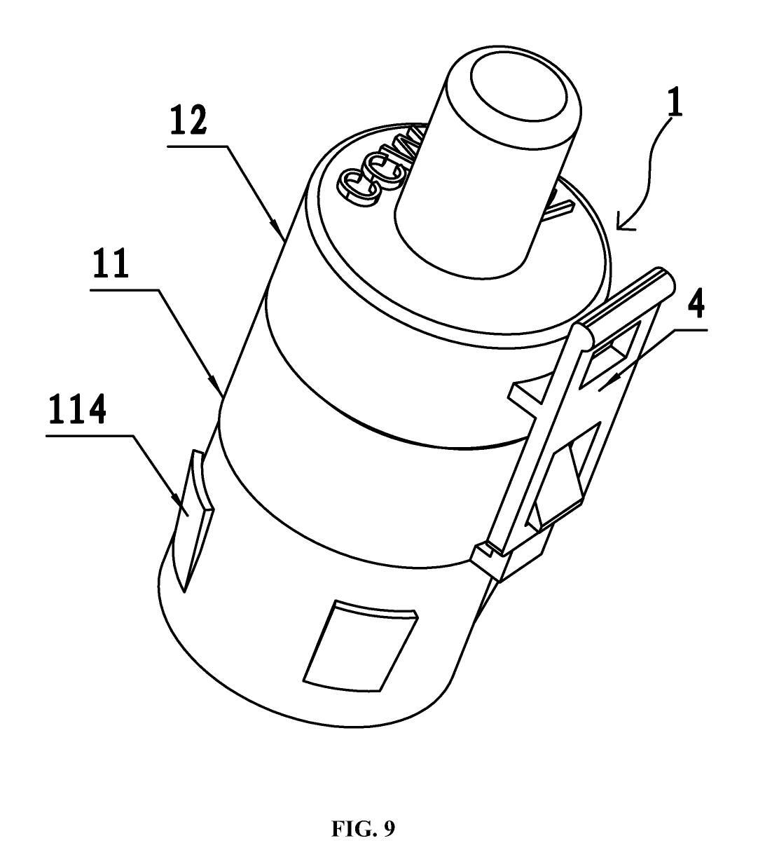

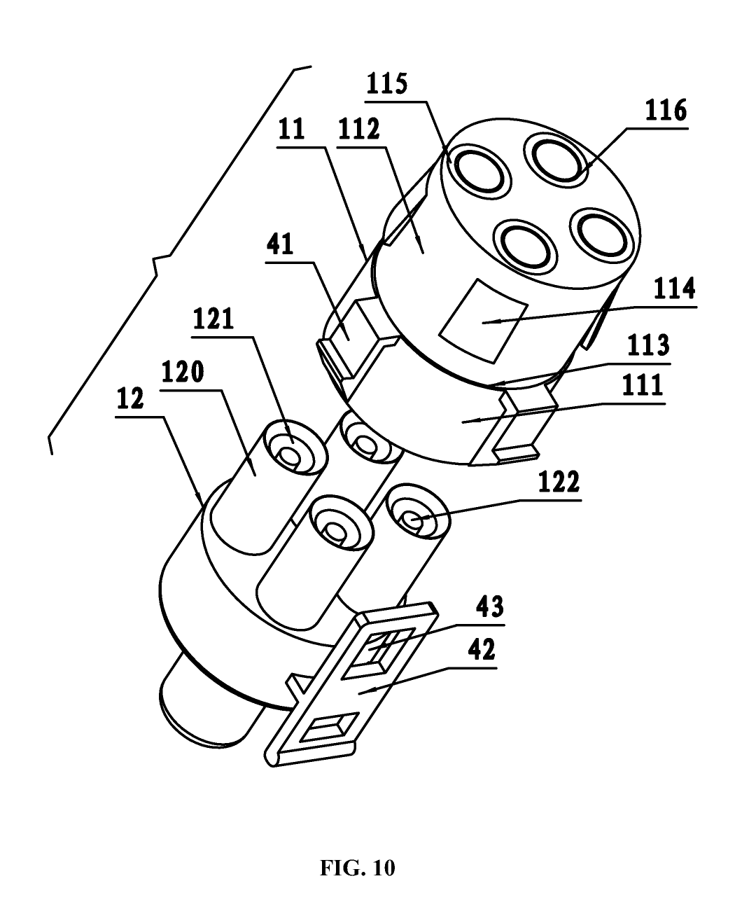

As shown in FIGS. 5-10, a reversing device 1 for a motor comprises a wired socket 11 and a reversing plug 12. The motor comprises a motor body. The wired socket 11 is mounted on the motor body and the reversing plug 12 is inserted in the wired socket 11. The wired socket 11 comprises a plurality of socket holes 115 with each having a terminal sleeve 116 and the coil winding is electrically connected with the terminal sleeves 116. The reversing plug 12 comprises a plurality of round pins 120. Each round pin 120 has a recess 121 that is mounted with a pin terminal 122, and every two pin terminals 122 are connected with each other. The round pins 120 are embedded in the socket holes 115 and the pin terminals 122 are connected with the terminal sleeves 116. The motor body is an end cover 3 of the motor. The wired socket 11 comprises an upper portion 111 and a lower portion 112, having a step surface 113 formed therebetween. The wired socket 11 is embedded in a slot 31 at the end surface of the motor end cover 3. A plurality of elastic clips 114 arranged on the outer side surface at the lower portion 112 of the wired socket 11 are clamped on the inner wall surface of the end cover 3 of the motor, and the step surface 113 presses on the outer surface of the end cover 3. The reversing device 1 is in the shape of a cylinder. The wired socket 11 and the reversing plug 12 are coupled together by a locking device 4. The locking device 4 comprises a buckle 41 projected from the wired socket 11 and a buckle plate 42 arranged on the reversing plug 12, in which the buckle 41 is fastened in a through hole 43 on the buckle plate 42. The reversing device 1 is arranged with a sign 5 to indicate the forward or reverse rotation.

The reversing device for a motor of the invention is applicable not only to the forward or reverse rotation but also to the high-low voltage conversion and speed adjustment.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A reversing device for a motor, the motor comprising a motor body, and the reversing device comprising a wired socket and a reversing plug, wherein the wired socket is mounted on the motor body and the reversing plug is inserted in the wired socket.

2. The reversing device for a motor of claim 1, wherein
the wired socket comprises a plurality of socket holes with each having a terminal sleeve and a coil winding is electrically connected with the terminal sleeves;
the reversing plug comprises a plurality of round pins, each round pin has a recess that is mounted with a pin terminal, and every two pin terminals are connected with each other;
the round pins are embedded in the socket holes; and
the pin terminals are connected with the terminal sleeves.

3. The reversing device for a motor of claim 1, wherein the motor body is a motor casing.

4. The reversing device for a motor of claim 2, wherein the motor body is a motor casing.

5. The reversing device for a motor of claim 4, wherein
two sides of the wired socket are arranged with clip slots;
the wired socket is embedded in a gap at the end of the motor casing;
the clip slots are fastened at two side walls of the gap; and
one end of an end cover of the motor presses on the bottom side surface of the wired socket.

6. The reversing device for a motor of claim 5, wherein the reversing device is in the shape of a cube.

7. The reversing device for a motor of claim 1, wherein the motor body is an end cover of the motor.

8. The reversing device for a motor of claim 2, wherein the motor body is an end cover of the motor.

9. The reversing device for a motor of claim 8, wherein
the wired socket comprises an upper portion and a lower portion and a step surface is formed therebetween;
the wired socket is embedded in a slot at the end surface of the end cover of the motor;
a plurality of elastic clips arranged on the outer side surface at the lower portion of the wired socket are clamped on the inner wall surface of the end cover of the motor; and
the step surface presses on the outer surface of the end cover of the motor.

10. The reversing device for a motor of claim 9, wherein the reversing device is in the shape of a cylinder.

11. The reversing device for a motor of claim 1, wherein the wired socket and the reversing plug are coupled together by a locking device.

12. The reversing device for a motor of claim 2, wherein the wired socket and the reversing plug are coupled together by a locking device.

13. The reversing device for a motor of claim 6, wherein the wired socket and the reversing plug are coupled together by a locking device.

14. The reversing device for a motor of claim 10, wherein the wired socket and the reversing plug are coupled together by a locking device.

15. The reversing device for a motor of claim 11, wherein the locking device comprises a buckle projected from the wired socket and a buckle plate arranged on the reversing plug, and the buckle is fastened in a through hole on the buckle plate.

16. The reversing device for a motor of claim 12, wherein the locking device comprises a buckle projected from the wired socket and a buckle plate arranged on the reversing plug, and the buckle is fastened in a through hole on the buckle plate.

17. The reversing device for a motor of claim 13, wherein the locking device comprises a buckle projected from the wired socket and a buckle plate arranged on the reversing plug, and the buckle is fastened in a through hole on the buckle plate.

18. The reversing device for a motor of claim 14, wherein the locking device comprises a buckle projected from the wired socket and a buckle plate arranged on the reversing plug, and the buckle is fastened in a through hole on the buckle plate.
